(19) United States
(12) Patent Application Publication
(10) Pub. No.: US 2006/0207398 A1
(43) Pub. Date: Sep. 21, 2006

(54) Saw blade

(76) Inventors: Peter John Nicolson, Cambridge (GB); Paul Edward Duggan, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/563,600

(22) PCT Filed: Jul. 8, 2004
(86) PCT No.: PCT/GB04/02949

§ 371 Date: Feb. 22, 2006

(30) Foreign Application Priority Data
Jul. 8, 2003 (GB) 0315904.3
Nov. 29, 2003 (GB) 0327752.2

(51) Int. Cl. B26D 1/00; B27B 33/02

(52) U.S. Cl. 83/13; 83/851; 83/855

(57) ABSTRACT

A saw blade has teeth grouped with varying shapes or other characteristics, such as composition. Each tooth has a root and a head separated by a transition region forming a neck. The roots may be oversize in relation to apertures or slots preformed in the strip, so that the teeth displace and deform the material of the strip, as they are forced into the position shown. They may then be fixed in position by brazing.

### FIELD OF THE INVENTION

This invention relates to saw blades, to methods of making saw blades and to teeth for such blades.

### BACKGROUND OF THE INVENTION

The applicants' published PCT Specification WO 01/83143 discloses methods of making saw blades by forcing tungsten carbide inserts into apertures in a comparatively soft carrier strip. Building on this technology, the present application is directed to developments which offer the opportunity of cost savings in manufacture of saw blades and greater versatility in the choice of the characteristics of the teeth of saw blades.

### SUMMARY OF THE INVENTION

According to a first aspect of the invention there is provided a plurality of hard teeth for attaching to a relatively soft common carrier of a saw blade, the teeth being of differing shapes and/or having different material compositions so that the resulting saw blade has teeth with different characteristics.

This aspect of the invention also provides a saw blade comprising a relatively soft carrier supporting a plurality of relatively hard teeth, wherein the teeth are of differing shapes and/or have different material compositions. The pitch of the teeth along the carrier may be constant or may vary. The carrier may be a carrier strip of a linear edge saw blade, the latter term including within its scope a rectilinear or curved blade.

A known linear edge saw blade is made by mounting identical inserts at spaced positions along a carrier strip, securing the inserts to the strip by brazing and then grinding the edges of the inserts and carrier strip to form a series of identically shaped teeth along the length of the blade. By pre-forming the inventive teeth in different shapes corresponding to the required final shape of the teeth, the grinding operations normally required to finish carbide tipped teeth are minimised or avoided, resulting in a significant cost saving. Moreover, different teeth along the length of a linear edge saw blade perform differing cutting functions dependent on their position in the cutting sequence. For example, leading teeth wear differently from trailing teeth. By recourse to the invention, individual teeth can be pre-formed to a required shape, and made of a composition as desired, without the need for substantial grinding. Thus, the characteristics of individual teeth can vary along the length of the carrier strip. In the preferred embodiment to be described, the teeth are in successive groups, with each group consisting of three teeth of different shapes, giving a successive triple cut configuration.

The invention also includes within its scope a method of making a saw blade, the method comprising fabricating a plurality of relatively hard teeth having differing shapes corresponding to the desired final shapes of the teeth of the blade, mounting the teeth at desired spaced mounting positions on a carrier of a relatively soft material and securing the teeth in their positions by brazing.

The mounting of the teeth in the carrier preferably causes deformation and displacement of the material of the carrier, and this may be achieved by forcing the teeth into apertures in the carrier. The teeth may have teeth roots with peripheries which form cutting edges to displace the material of the carrier as the inserts are forced into position.

The invention is also applicable to circular saws, in which case the carrier is in the shape of a disc around the outer periphery on which the teeth are supported.

According a yet further aspect of the invention there is provided a tooth for a saw blade, the tooth having a root for attachment to a carrier of the blade and a head forming a cutting portion of the tooth when the latter is advanced in the cutting direction, the root and head being separated by a transition region which, when the tooth is viewed in side view transverse to the cutting direction, is in the shape of a neck as a consequence of having a width less than the maximum width of the root and less than the maximum width of the head.

The root may have a periphery which is curvilinear in side view, the curvilinear edge being sufficiently sharp to enable the insert to be forced into the carrier from one side thereof, optionally being forced into a pre-formed pilot slot or hole in the carrier with attendant displacement and deformation of the material of the carrier, prior to the tooth being secured in position by brazing. Each tooth may cut its own aperture, a pre-formed slot or hole in the carrier not then being necessary.

The invention includes within its scope a saw blade comprising a carrier supporting a plurality of teeth each in accordance with the yet further aspect of the invention. Also included within the invention is a method of making a saw blade, the method comprising mounting teeth, each in accordance with the yet further aspect of the invention, on a comparatively soft carrier.

In its further aspect, the invention is applicable to linear edge saw blades and to circular saw blades. In the former case, the carrier is in the form of an elongate carrier strip and in the latter case the carrier is disc-shaped.

### BRIEF DESCRIPTION OF THE DRAWINGS

The invention will now be further described, by way of example, with reference to the accompanying drawings, in which:

FIGS. 1 to 3 are perspective views of three individual teeth according to the invention;

FIG. 4 is a composite view illustrating in end view the three teeth of FIGS. 1 to 3;

FIG. 5 is a perspective view of a first form of carrier strip showing teeth being mounted therein;

FIG. 6 is a side elevation of the carrier strip of FIG. 5;

FIG. 7 is a perspective view showing the three teeth of FIGS. 1 to 3 mounted in the carrier strip of FIG. 5;

FIG. 8 is a side elevation corresponding to FIG. 6, but showing an alternative shape of carrier strip;

FIG. 9 illustrates the use of the blade of FIG. 7 to form reciprocating blades; and

FIG. 10 illustrates a circular saw blade corresponding with the blade of FIG. 7.

### DETAILED DESCRIPTION OF THE DRAWINGS

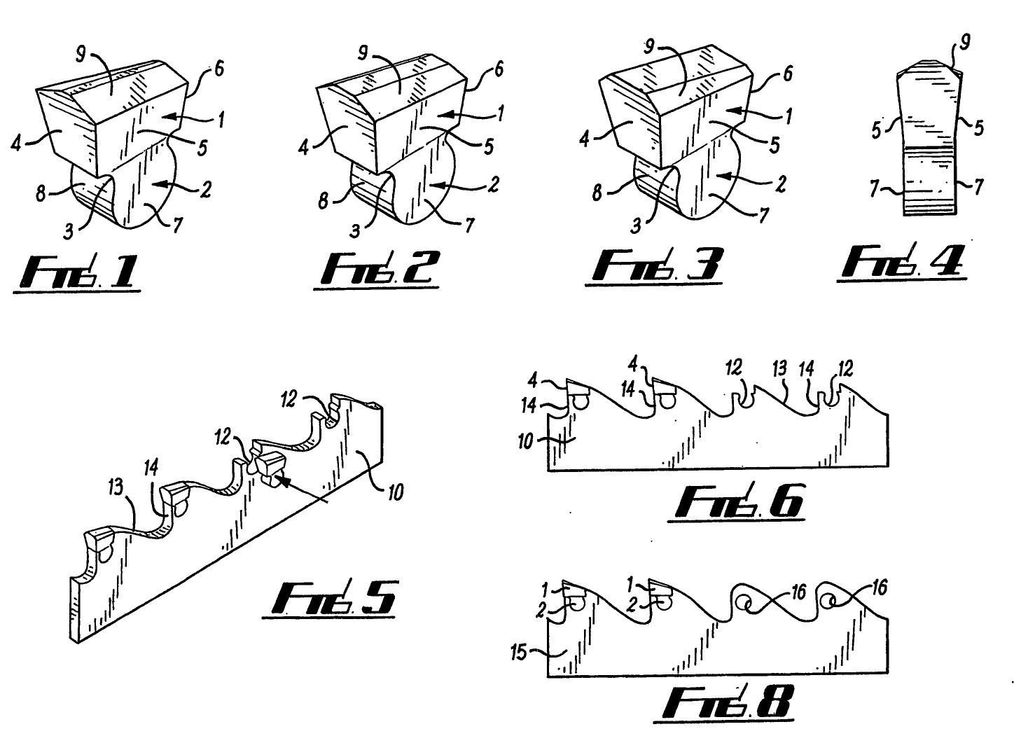

FIGS. 1 to 3 show teeth for a saw blade. Each tooth is moulded from tungsten carbide material in the shape illustrated, the tooth having a head 1 and a root 2 with a transition region 3 therebetween. Each head 1 has a planar front face 4, planar sides 5 and a planar rear face 6. As can be seen from FIG. 4, the planar sides 5 are non parallel, converging slightly in a direction towards the root 2 of the tooth. Each root 2 has planar parallel side faces 7 which join a convex curved wall 8 along curved edges, giving the root 2 a part-circular shape in side view. On one side of the tooth, the curved edge acts as a cutting edge when the tooth is mounted on the edge of the carrier strip.

At the transition region 3, the convex wall 8 merges smoothly into a concave wall at the front of the tooth and into a concave wall at the rear of the tooth, these two concave walls merging into respective shoulders where they are adjoin the head of the tooth. As a result, when each tooth is viewed from the side the transition region 3 forms a neck which has a narrower width than the maximum width of the head 1 and a narrower width than the maximum width of the root 2.

The teeth of FIGS. 1 to 3 differ their characteristics. In particular, they differ in the shapes of the upper portions of their heads. The tooth of FIG. 1 has a comparatively large chamfer 9 formed (by moulding of the tooth) along each top edge, the tooth of FIG. 3 has a comparatively small chamfer 9 formed along each top edge and the tooth of FIG. 2 has an intermediate size of chamfer 9. As a consequence, the front cutting faces 4 of the teeth present different shapes and different cutting areas. The teeth of FIGS. 1 to 3 may also differ in composition or other characteristics.

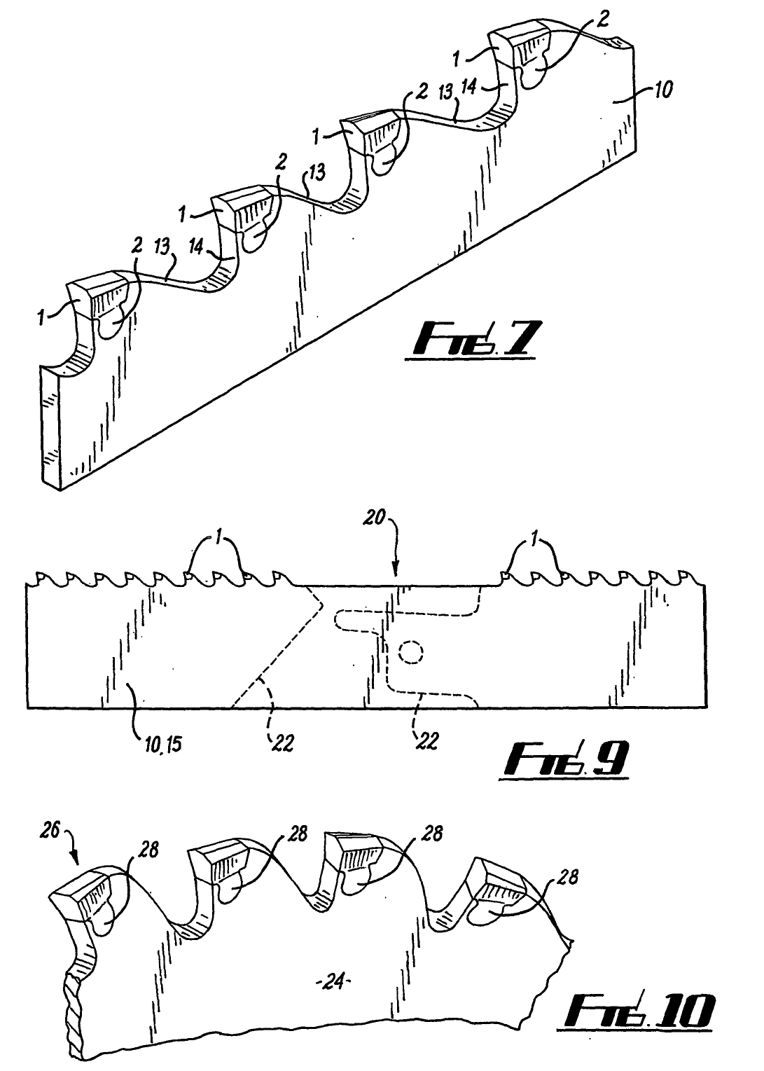

The three teeth of FIGS. 1 to 3 form a group of three teeth which are mounted in the carrier strip 10 (FIGS. 5 and 6) which is made from a flexible steel strip which is comparatively soft in relation to the hard material of the teeth. The carrier strip 10 is punched to have the profile shown in FIG. 6, there being at regularly spaced positions a series of apertures each in the form of an arcuate slot 12 open to the edge of the carrier strip 10. Between adjacent slots 12 the carrier strip edge has an inclined portion 13 merging into a vertical portion 14.

The root 2 of each tooth is oversize in relation to the slot 12 and each root is forced into a corresponding slot 12, as indicated by the arrow in FIG. 5, with attendant displacement and deformation of the material of the carrier strip 10. When the teeth have been located in the carrier strip edge in this manner, the teeth are anchored in the carrier strip by brazing. The shape of the neck and the provision of shoulders between the neck and the head contribute to a firm attachment of each tooth in the strip 10. As best seen from FIG. 6, the front face 4 of each tooth forms a smooth continuation with the corresponding vertical wall portion 14 and the inclined wall portion 13 forms a smooth continuation of the chamfered top edge of each tooth. By pre-forming the shapes of the teeth, there is no need for a grinding operation to be carried out, although a small degree of finish grinding may be carried out.

FIG. 7 shows the group of three teeth mounted in the carrier strip 10 and also the first tooth of the next group. Thus, the resulting linear edge saw blade has successive groups of teeth, with each group consisting of the three teeth shown in FIGS. 1 to 3. The cutting direction is towards the left as the blade is viewed in FIG. 7.

FIG. 8 shows a modified shape of carrier strip 15 where each aperture is in the form of a hole 16 punched through the strip near the edge of the latter, instead of being a slot open to the edge of the strip. Each tooth is punched into a corresponding hole 16, the result being as shown at the left hand end of FIG. 8.

FIGS. 5 to 8 show carrier strips 10 and 15 where the teeth are forced into pre-formed apertures from the side of the carrier strip. Instead, the teeth may be forced downwardly, into slots in a carrier strip, relying on the elasticity of the latter to receive and then retain the teeth prior to brazing.

FIG. 9 illustrates a position along the strip 10 or 15, at which there is a relatively large gap 20 between teeth. This allows the strip 10, 15 to be cut or stamped to form reciprocating saw blades of a desired length and tang style, for example by separating the blade along the broken lines 22 of FIG. 9.

FIGS. 5 and 7 show the teeth being mounted on a carrier strip of a linear edge saw blade. When the invention is applied to a circular saw blade, a disc-like carrier 24 (FIG. 10) has an outer periphery 26 around which the groups of teeth 28 (corresponding to the teeth of FIGS. 1 and 4) are mounted, preferably by being forced into the edge of the softer carrier 24 in a manner similar to that described for the linear edge saw blade. Thus, each tooth has a root with a cutting edge enabling the tooth to be forced into the edge of the carrier with attendant displacement and deformation of the material of the carrier. This locates the tooth in the carrier 24 prior to brazing.

Thus, for both the linear edge and circular saw blades, the waisted teeth punch their own keyways in the carrier to locate the teeth in the carrier, after which the teeth are anchored in position by brazing.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A saw blade comprising a relatively soft carrier supporting a plurality of relatively hard teeth, wherein the teeth are of differing characteristics.

2. A blade according to claim 1, wherein the teeth differ in shape.

3. A blade according to claim 1, wherein the teeth differ in composition.

4. A blade according to claim 1, wherein the pitch of the teeth along the carrier is constant.

5. A blade according to claim 1, wherein the pitch of the teeth varies along the carrier.

6. A blade according to claim 1, wherein the blade has a linear edge.

7. A blade according to claim 1, wherein the blade has a curved edge.

8. A blade according to claim 7, the blade edge being circular.

9. A method of making a saw blade, the method comprising fabricating a plurality of relatively hard teeth having differing characteristics, mounting the teeth at desired spaced mounting positions on a carrier of a relatively soft material and securing the teeth in their positions.

10. A method according to claim 9, wherein the teeth differ in shape.

11. A method according to claim 9, wherein the teeth differ in composition.

12. A method according to claim 9 wherein the mounting of the teeth in the carrier causes deformation and displacement of the material of the carrier.

13. A method according to claim 12, wherein deformation and displacement is achieved by forcing the teeth into apertures in the carrier.

14. A method according to claim 13, wherein the teeth have teeth roots with peripheries which form cutting edges to displace the material of the carrier as the inserts are forced into position.

15. A method according to claim 9, wherein the pitch of the teeth along the carrier is constant.

16. A method according to claim 9, wherein the pitch of the teeth varies along the carrier.

17. A method according to claim 9, wherein the blade has a linear edge.

18. A method according to claim 9, wherein the blade has a curved edge.

19. A method according to claim 18, wherein the blade edge is circular.

20. A plurality of hard teeth for attaching to a relatively soft common carrier of a saw blade, the teeth being of differing characteristics so that the resulting saw blade has teeth with different characteristics.

21. A plurality of teeth according to claim 20, wherein the teeth differ in shape.

22. A plurality of teeth according to claim 20, wherein the teeth differ in composition.

23. A tooth for a saw blade, the tooth having a root for attachment to a carrier of the blade and a head forming a cutting portion of the tooth when the latter is advanced in the cutting direction, the root and head being separated by a transition region which, when the tooth is viewed in side view transverse to the cutting direction, is in the shape of a neck as a consequence of having a width less than the maximum width of the root and less than the maximum width of the head.

24. A tooth according to claim 23, wherein the root has a periphery which is curvilinear in side view, the curvilinear edge being sufficiently sharp to enable the insert to be forced into the carrier from one side thereof.

25. A tooth according to claim 23, wherein the tooth is shaped to be forced into a pre-formed pilot slot or hole in the carrier with attendant displacement and deformation of the material of the carrier.

26. A saw blade comprising a carrier supporting a plurality of teeth each in accordance with claim 23.

27. (canceled)

28. A method of making a saw blade, in which relatively hard teeth in accordance with claim 23 are mounted on a relatively soft carrier.

29-31. (canceled)
